(19) United States
(12) Patent Application Publication
(10) Pub. No.: US 2026/0168555 A1
(43) Pub. Date: Jun. 18, 2026

(54) LIQUID FILLED VIBRATION DAMPING DEVICE AND MANUFACTURING METHOD THEREOF

(71) Applicant: HONDA MOTOR CO., LTD., Tokyo (JP)

(72) Inventors: Takumichi SO, Saitama (JP); Toshio INOUE, Saitama (JP); Yuho ITO, Saitama (JP)

(21) Appl. No.: 19/359,794

(22) Filed: Oct. 16, 2025

(30) Foreign Application Priority Data
Dec. 12, 2024 (JP) 2024-217310

(51) Int. Cl. F16F 9/10; F16F 9/32; F16F 9/43

(52) U.S. Cl. CPC F16F 9/10; F16F 9/3271; F16F 9/43

(57) ABSTRACT

A liquid filled vibration damping device includes a first member having a first surface, and a second member having a second surface facing the first surface. The first surface of the first member is provided with a storing recess configured to store a liquid, and a fitting recess formed continuously with the storing recess and provided on a top surface of the storing recess. The second surface of the second member is provided with a fitting portion configured to fit into the fitting recess.

### TECHNICAL FIELD

The present invention relates to a liquid filled vibration damping device and a manufacturing method thereof

### BACKGROUND ART

Conventionally, a liquid filled vibration damping device that has a space configured to store a liquid is known. As a technique for storing the liquid in the space, JPH11-125297A discloses a technique of making the pressure of the space negative beforehand by a vacuum pump and then filling the space with the liquid

However, in the above conventional technique, it is necessary to make the pressure of the space negative beforehand, which may increase the man-hours to store the liquid. Further, in a case where a liquid with high viscosity (that is, a liquid with poor flowability) is to be stored in the space, the liquid may not be efficiently stored in the space

### SUMMARY OF THE INVENTION

In view of the above background, an object of the present invention is to provide a liquid-filled vibration damping device and a manufacturing method thereof that can efficiently store a liquid regardless of the viscosity of the liquid and reduce the man-hours to store the liquid

To achieve such an object, one aspect of the present invention provides a liquid filled vibration damping device, comprising: a first member having a first surface; and a second member having a second surface facing the first surface, wherein the first surface of the first member is provided with: a storing recess configured to store a liquid; and a fitting recess formed continuously with the storing recess and provided on a top surface of the storing recess, and the second surface of the second member is provided with a fitting portion configured to fit into the fitting recess

To achieve such an object, another aspect of the present invention provides a manufacturing method of the liquid filled vibration damping device comprising: a filling process of filling the storing recess and the fitting recess with the liquid; and a fitting process of fitting the fitting portion into the fitting recess, wherein after completing the filling process and while performing the fitting process, vacuum defoaming of the liquid is started

To achieve such an object, another aspect of the present invention provides a manufacturing method of the liquid filled vibration damping device comprising: a filling process of filling the storing recess and the fitting recess with the liquid; and a fitting process of fitting the fitting portion into the fitting recess and thereby causing the liquid in the fitting recess to overflow and defoaming the liquid

Thus, according to the above aspects, it is possible to provide a liquid filled vibration damping device and a manufacturing method thereof that can efficiently store a liquid regardless of the viscosity of the liquid and reduce the man-hours to store the liquid

### BRIEF DESCRIPTION OF THE DRAWING(S)

FIG. 1 is a cross-sectional view showing a liquid filled vibration damping device according to an embodiment of the present invention

FIG. 2 is a perspective view showing a first member according to the embodiment of the present invention

FIG. 3 is a partially cutaway perspective cross-sectional view showing the first member according to the embodiment of the present invention

FIG. 4 is a perspective view showing a second member according to the embodiment of the present invention

FIG. 5A is an explanatory diagram showing a filling process in a manufacturing method of the liquid filled vibration damping device according to the embodiment of the present invention

FIG. 5B is an explanatory diagram showing a vacuuming process in the manufacturing method of the liquid filled vibration damping device according to the embodiment of the present invention

FIG. 6A is an explanatory diagram showing the start of a fitting process in the manufacturing method of the liquid filled vibration damping device according to the embodiment of the present invention

FIG. 6B is an explanatory diagram showing the completion of the fitting process in the manufacturing method of the liquid filled vibration damping device according to the embodiment of the present invention

FIG. 7 is a bottom view of a vehicle to which the liquid filled vibration damping device according to the embodiment of the present invention is applied

FIG. 8 is a side cross-sectional view showing a mounting member and its surroundings in the vehicle to which the liquid filled vibration damping device according to the embodiment of the present invention is applied; and

FIG. 9 is a cross-sectional view showing a liquid filled vibration damping device according to another embodiment of the present invention

### DETAILED DESCRIPTION OF THE INVENTION

In the following, embodiments of a liquid filled vibration damping device and a manufacturing method thereof will be described with reference to the drawings.

### the liquid filled vibration damping device 1

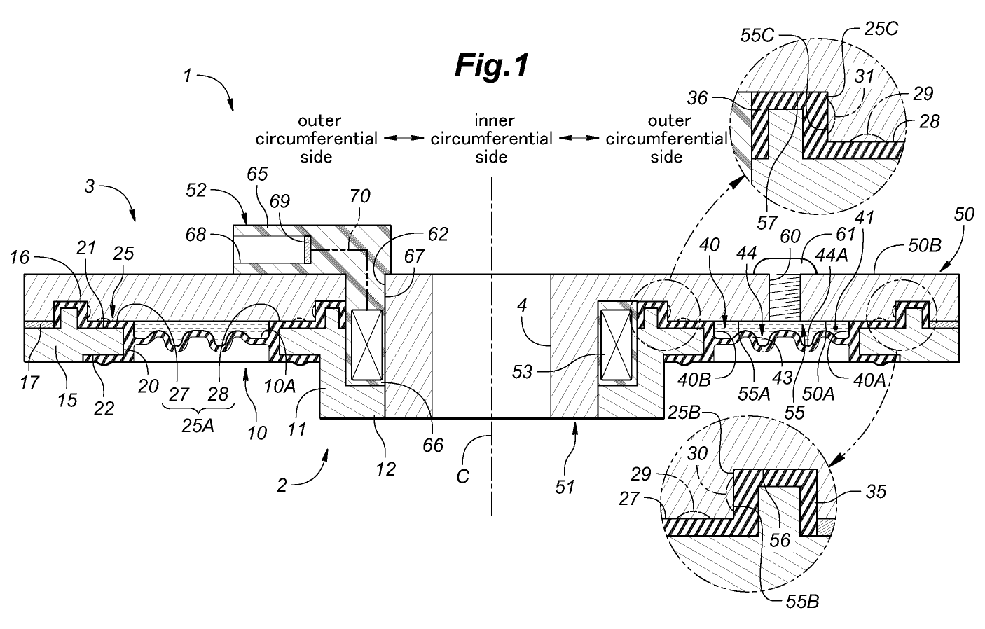

First, a liquid filled vibration damping device 1 (hereinafter abbreviated as "the vibration damping device 1") will be described. In the following, for ease of explanation, the terms indicating directions such as "upward" and "downward" will be used based on the posture in FIG. 1 (i.e., the posture at the completion of manufacture) of the vibration damping device 1. However, the posture of the vibration damping device 1 during actual use is not limited to the posture in FIG. 1 of the vibration damping device 1, and can be freely changed according to the layout of the vibration damping device 1 and the like.

With reference to FIG. 1, the vibration damping device 1 has an annular shape centered on a central axis C. Hereinafter, the side close to the central axis C will be referred to as "the inner circumferential side", and the side away from the central axis C will be referred to as "the outer circumferential side". Hereinafter, a simple term "the radial direction" indicates the radial direction centered on the central axis C, and a simple term "circumferential direction" indicates the circumferential direction centered on the central axis C. The vibration damping device 1 includes a first member 2 and a second member 3 attached to the first member 2.

### the first member 2

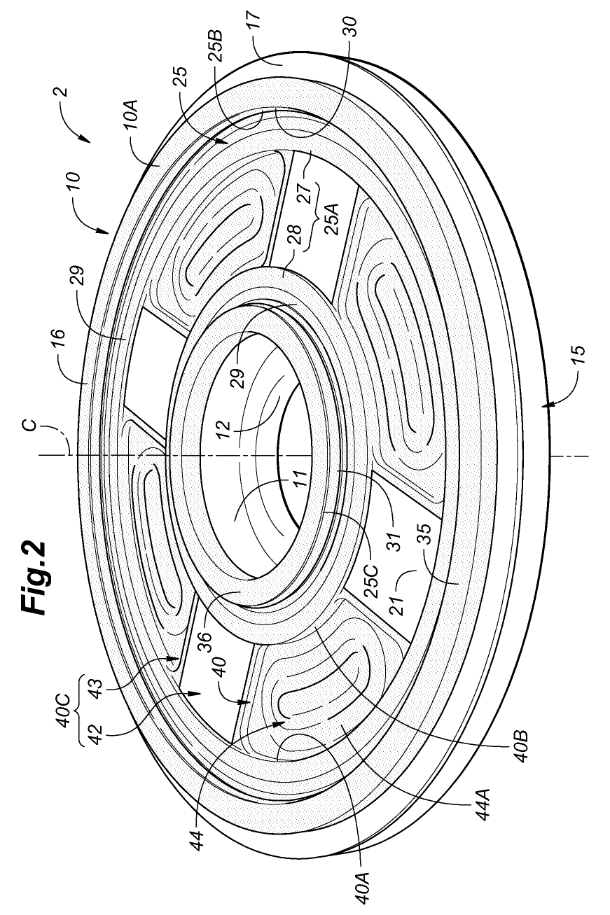

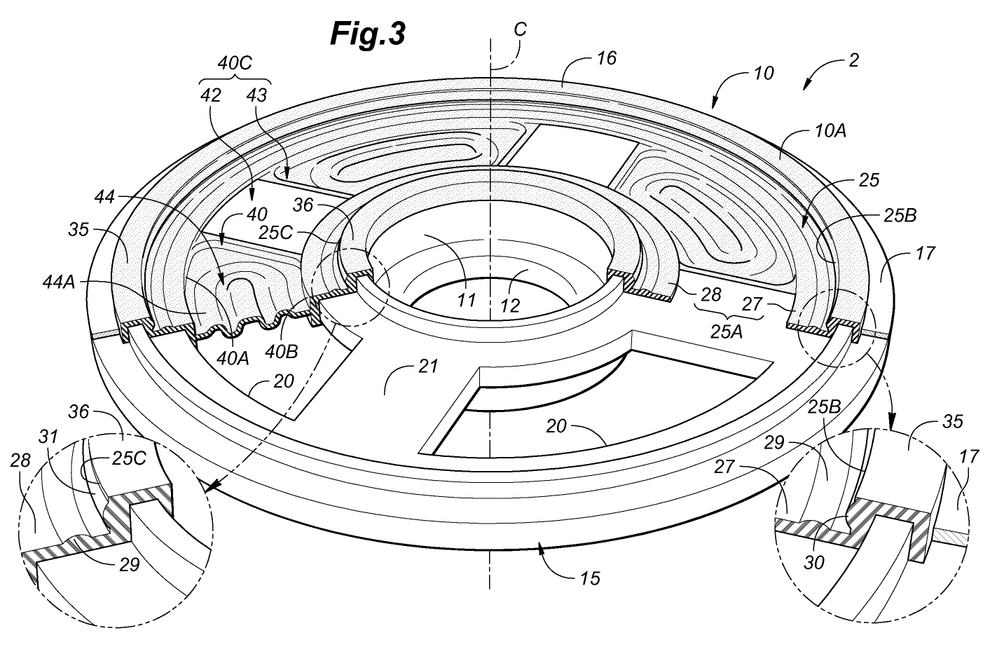

With reference to FIGS. 1 to 3, the first member 2 includes a first annular portion 10 having an annular shape centered on the central axis C, a first tubular portion 11 protruding downward from the end of the first annular portion 10 on the inner circumferential side and having a cylindrical shape (tubular shape) centered on the central axis C, and an inner circumferential wall 12 protruding from the lower end of the first tubular portion 11 toward the inner circumferential side and having an annular shape centered on the central axis C.

The first annular portion 10 of the first member 2 includes a base member 15, and a membrane 16 (an example of an elastic member) and a ring 17 that are attached to the base member 15. The base member 15, the membrane 16, and the ring 17 are provided separately from each other.;

The base member 15 of the first annular portion 10 has an annular shape centered on the central axis C. The base member 15 is provided with a plurality of openings 20 spaced apart in the circumferential direction. Each opening 20 penetrates the base member 15 from an upper surface 21 thereof to a lower surface 22 thereof. The base member 15 is made of a metal such as iron.

The membrane 16 of the first annular portion 10 has an annular shape centered on the central axis C. The membrane 16 covers a portion of the upper surface 21 of the base member 15, a portion of the lower surface 22 of the base member 15, and the plurality of openings 20 of the base member 15. The membrane 16 is made of an elastic material such as rubber. The rigidity of the membrane 16 is lower than the rigidity of the base member 15.

The ring 17 of the first annular portion 10 has an annular shape centered on the central axis C. The ring 17 is attached to the end of the upper surface 21 of the base member 15 on the outer circumferential side. The ring 17 is arranged on the outer circumferential side of the membrane 16.

An upper surface 10A of the first annular portion 10 (an example of a first surface of the first member) is provided with a fitting recess 25. The fitting recess 25 has an annular shape centered on the central axis C. The fitting recess 25 is formed continuously with a storing recess 40 (that will be described later) and provided on an upper surface (one example of a top surface) of the storing recess 40. The fitting recess 25 is formed by the membrane 16. Each of an outer circumferential portion 27 and an inner circumferential portion 28 of a bottom surface 25A of the fitting recess 25 is provided with an annular raised portion 29 raised upward. An outer circumferential surface 25B of the fitting recess 25 is provided with an annular protruding portion 30 protruding laterally, and an inner circumferential surface 25C of the fitting recess 25 is provided with an annular protruding portion 31 protruding laterally.

The upper surface 10A of the first annular portion 10 is provided with an outer circumferential protrusion 35 on the outer circumferential side of the fitting recess 25. The outer circumferential protrusion 35 is formed continuously with the fitting recess 25. The inner circumferential surface of the outer circumferential protrusion 35 defines the outer circumferential surface 25B of the fitting recess 25. The outer circumferential protrusion 35 protrudes perpendicularly to the upper surface 10A of the first annular portion 10. The outer circumferential protrusion 35 has an annular shape centered on the central axis C. The outer circumferential protrusion 35 is formed by the base member 15 and the membrane 16.

The upper surface 10A of the first annular portion 10 is provided with an inner circumferential protrusion 36 on the inner circumferential side of the fitting recess 25. The inner circumferential protrusion 36 is formed continuously with the fitting recess 25. The outer circumferential surface of the inner circumferential protrusion 36 defines the inner circumferential surface 25C of the fitting recess 25. The inner circumferential protrusion 36 protrudes perpendicularly to the upper surface 10A of the first annular portion 10. The inner circumferential protrusion 36 has an annular shape centered on the central axis C. The inner circumferential protrusion 36 is formed by the base member 15 and the membrane 16.

The upper surface 10A of the first annular portion 10 is provided with the storing recess 40. The storing recess 40 has an annular shape centered on the central axis C. The storing recess 40 is recessed downward from a radially central portion of the bottom surface 25A of the fitting recess 25. The storing recess 40 is configured to store a magnetic fluid 41 (an example of a liquid). In another embodiment, the storing recess 40 may be configured to store a non-magnetic fluid. An outer circumferential surface 40A and an inner circumferential surface 40B of the storing recess 40 are formed by the membrane 16. A bottom surface 40C of the storing recess 40 is provided with a plurality of rigid portions 42 formed by the base member 15 and a plurality of elastic portions 43 formed by the membrane 16. The plurality of rigid portions 42 and the plurality of elastic portions 43 are arranged alternately in the circumferential direction. A portion of each elastic portion 43 is received in each opening 20 of the base member 15. The portion (i.e., the portion received in each opening 20 of the base member 15) of each elastic portion 43 is provided with a groove portion 44 recessed downward. A bottom surface 44A of the groove portion 44 is provided with an uneven shape.

The first tubular portion 11 and the inner circumferential wall 12 of the first member 2 are provided integrally with the base member 15 of the first annular portion 10. The first tubular portion 11 and the inner circumferential wall 12 are provided separately from the membrane 16 and the ring 17 of the first annular portion 10.

### the second member 3

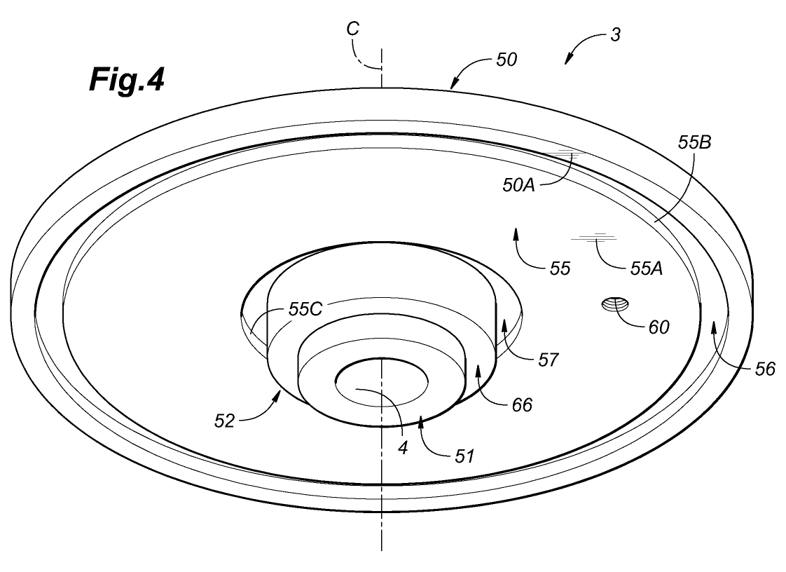

With reference to FIGS. 1 and 4, the second member 3 includes a second annular portion 50 having an annular shape centered on the central axis C, a second tubular portion 51 protruding downward from the end of the second annular portion 50 on the inner circumferential side and having a cylindrical shape (tubular shape) centered on the central axis C, a connector 52 attached to the second annular portion 50 and the second tubular portion 51, and a coil 53 held by the connector 52.

A lower surface 50A of the second annular portion 50 of the second member 3 (an example of a second surface of the second member) faces the upper surface 10A of the first annular portion 10. The second annular portion 50 does not contact with the base member 15 of the first annular portion 10, but contacts with the membrane 16 and the ring 17 of the first annular portion 10.

The lower surface 50A of the second annular portion 50 is provided with a fitting portion 55. The fitting portion 55 has an annular shape centered on the central axis C. A lower surface 55A of the fitting portion 55 abuts against the bottom surface 25A of the fitting recess 25 of the first member 2 so as to cover the upper surface (an example of the top surface) of the storing recess 40 of the first member 2. The lower surface 55A of the fitting portion 55 abuts against the raised portion 29 provided on the bottom surface 25A of the fitting recess 25, thereby elastically deforming the raised portion 29. An outer circumferential surface 55B of the fitting portion 55 fits into the outer circumferential surface 25B of the fitting recess 25. The outer circumferential surface 55B of the fitting portion 55 abuts against the protruding portion 30 provided on the outer circumferential surface 25B of the fitting recess 25, thereby elastically deforming the protruding portion 30. An inner circumferential surface 55C of the fitting portion 55 fits into the inner circumferential surface 25C of the fitting recess 25. The inner circumferential surface 55C of the fitting portion 55 abuts against the protruding portion 31 provided on the inner circumferential surface 25C of the fitting recess 25, thereby elastically deforming the protruding portion 31.

The lower surface 50A of the second annular portion 50 is provided with an outer circumferential recess 56 on the outer circumferential side of the fitting portion 55. The outer circumferential recess 56 is formed continuously with the fitting portion 55. The outer circumferential recess 56 has an annular shape centered on the central axis C. The outer circumferential protrusion 35 of the first member 2 fits into the outer circumferential recess 56.

The lower surface 50A of the second annular portion 50 is provided with an inner circumferential recess 57 on the inner circumferential side of the fitting portion 55. The inner circumferential recess 57 is formed continuously with the fitting portion 55. The inner circumferential recess 57 has an annular shape centered on the central axis C. The inner circumferential protrusion 36 of the first member 2 fits into the inner circumferential recess 57.

The radially central portion of the second annular portion 50 is provided with a through hole 60. The through hole 60 penetrates the second annular portion 50 from the lower surface 50A (an example of a second surface of the second member) thereof to an upper surface 50B (an example of a surface of the second member facing away from the second surface) thereof. The lower end (the end close to the second surface) of the through hole 60 opens toward the storing recess 40 of the first member 2. The through hole 60 is closed by a plug 61. The plug 61 is made of, for example, a screw or a ball. The end of the second annular portion 50 on the inner circumferential side is provided with a connecting hole 62. The connecting hole 62 penetrates the second annular portion 50 from the lower surface 50A thereof to the upper surface 50B thereof.

The second tubular portion 51 of the second member 3 is provided integrally with the second annular portion 50. The outer circumferential surface of the second tubular portion 51 fits into the inner circumferential wall 12 of the first member 2. The inner circumferential surface of the second tubular portion 51 defines a central hole 4.

The connector 52 of the second member 3 includes a main body 65 provided along the upper surface 50B of the second annular portion 50, a coil holding portion 66 provided on the outer circumferential side of the second tubular portion 51, and a connecting portion 67 that penetrates through the connecting hole 62 of the second annular portion 50 and connects the main body 65 and the coil holding portion 66. The main body 65 is provided with a fitting groove 68 into which a power supply terminal (not shown) can fit. The fitting groove 68 is provided with a power receiving terminal 69 that is connectable to the power supply terminal.

The coil 53 of the second member 3 has a cylindrical shape (tubular shape) centered on the central axis C. The coil 53 is arranged coaxially with the first tubular portion 11 of the first member 2 and the second tubular portion 51 of the second member 3. The coil 53 is arranged on the inner circumferential side of the first tubular portion 11 and on the outer circumferential side of the second tubular portion 51. The coil 53 is held by the coil holding portion 66 of the connector 52. The coil 53 and the storing recess 40 of the first member 2 are aligned in the radial direction.

The coil 53 is connected to the power receiving terminal 69 of the connector 52 via a wire 70. When a current is supplied to the coil 53 from the power receiving terminal 69 via the wire 70, the coil 53 generates a magnetic field. Accordingly, the magnetic field is applied to the magnetic fluid 41 in the storing recess 40, and the metal particles in the magnetic fluid 41 are aligned in the direction of the magnetic field. This increases the viscous resistance of the magnetic fluid 41 in a direction perpendicular to the direction of the magnetic field, and increases the rigidity of the vibration damping device 1 the manufacturing method of the vibration damping device 1.

Next, the manufacturing method of the vibration damping device 1 configured as described above will be described.

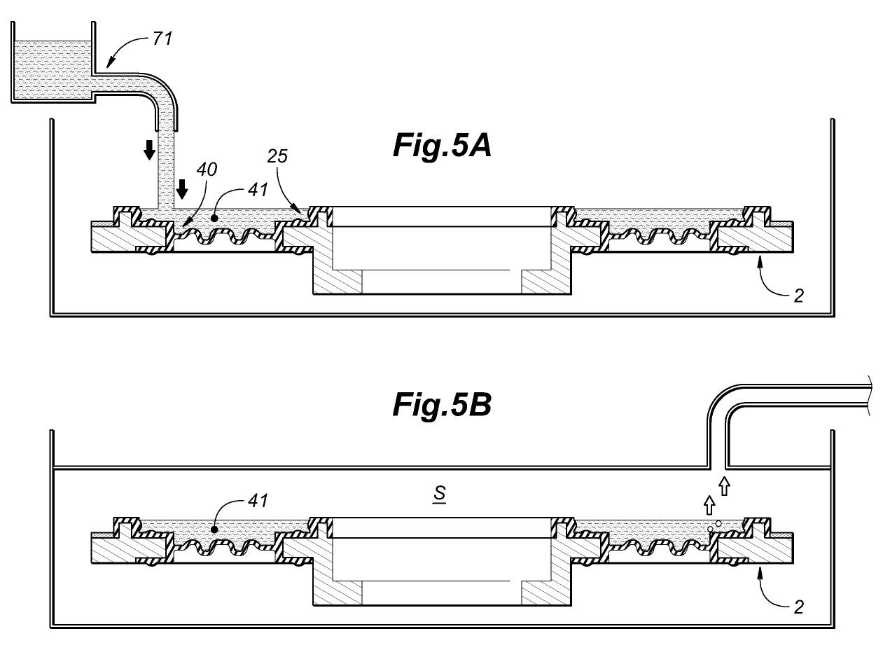

With reference to FIG. 5A, the operator first executes a filling process. In the filling process, the operator fills the storing recess 40 and the fitting recess 25 of the first member 2 with the magnetic fluid 41 by using a filling device 71. By filling the storing recess 40 and the fitting recess 25 with the magnetic fluid 41 in this manner, it is possible to fill the first member 2 with the magnetic fluid 41 whose volume is larger than the capacity of the storing recess 40.

With reference to FIG. 5B, after the filling process is completed, the operator executes a vacuuming process. In the vacuuming process, the operator arranges the first member 2 in a sealed space S and vacuums the sealed space S. This increases the buoyancy of the air bubbles in the magnetic fluid 41, thereby causing the air bubbles in the magnetic fluid 41 to be released from the upper surface of the magnetic fluid 41. That is, the magnetic fluid 41 is defoamed.

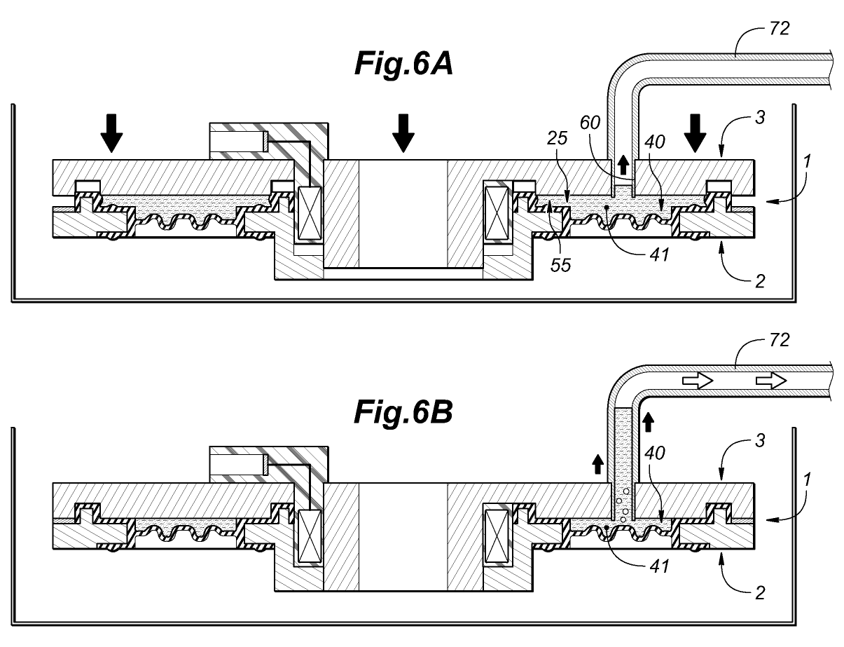

With reference to FIGS. 6A and 6B, after the vacuuming process is completed, the operator performs a fitting process. In the fitting process, the operator connects a discharge pipe 72 to the through hole 60 of the second member 3. Further, the operator arranges the second member 3 above the first member 2 and presses down the second member 3 toward the first member 2, thereby fitting the fitting portion 55 of the second member 3 into the fitting recess 25 of the first member 2 from above. When the fitting portion 55 fits into the fitting recess 25 in this manner, the magnetic fluid 41 in the fitting recess 25 overflows and is discharged to the discharge pipe 72 via the through hole 60. Accordingly, the air bubbles in the magnetic fluid 41 are discharged from the upper surface of the magnetic fluid 41 to the discharge pipe 72. That is, the magnetic fluid 41 is defoamed.

In the present embodiment, between the start of the fitting process (see FIG. 6A) and the completion of the fitting process (see FIG. 6B), the operator starts vacuuming of the magnetic fluid 41 using a vacuuming device (not shown) connected to the discharge pipe 72. That is, in the present embodiment, after completing the filling process and while performing the fitting process, the operator starts vacuum defoaming of the magnetic fluid 41. Accordingly, the pressure of the space defined by the storing recess 40, the fitting recess 25, and the fitting portion 55 (i.e., the space storing the magnetic fluid 41) is made negative, which generates a force that pulls the fitting portion 55 downward (toward the storing recess 40). Accordingly, the fitting portion 55 can fit into the fitting recess 25 with a smaller force.

With reference to FIG. 1, when the fitting process is completed, the operator removes the discharge pipe 72 from the through hole 60 and closes the through hole 60 with the plug 61. This completes the manufacture of the vibration damping device 1. In another embodiment, a portion or all of the above-mentioned manufacturing method of the vibration damping device 1 may be automatically performed by a manufacturing device provided with a computer.

### effects

The capacity of the liquid chamber between the first member 2 and the second member 3 at the start of the fitting process (i.e., the total volume of the storing recess 40 and the fitting recess 25: see FIG. 6A) is greater than the capacity of the liquid chamber between the first member 2 and the second member 3 at the completion of the fitting process (i.e., the volume of the storing recess 40: see FIG. 6B). Accordingly, when the fitting process is executed, a portion of the magnetic fluid 41 stored in the liquid chamber between the first member 2 and the second member 3 overflows. This allows the magnetic fluid 41 to be defoamed efficiently.

Incidentally, one possible method for filling the storing recess 40 and the fitting recess 25 with the magnetic fluid is to attach the second member 3 to the first member 2 within the magnetic fluid 41. However, when such a method is applied, the magnetic fluid 41 adheres to the entire vibration damping device 1, which makes the cleaning work of the vibration damping device 1 troublesome if the viscosity of the magnetic fluid 41 is high. In contrast, according to the present embodiment, since only the storing recess 40 and the fitting recess 25 are locally filled with the magnetic fluid 41 (see FIG. 5A), the magnetic fluid 41 does not adhere to the entire vibration damping device 1. This makes the cleaning work of the vibration damping device 1 easy even if the viscosity of the magnetic fluid 41 is high.

### the application example of the vibration damping device 1

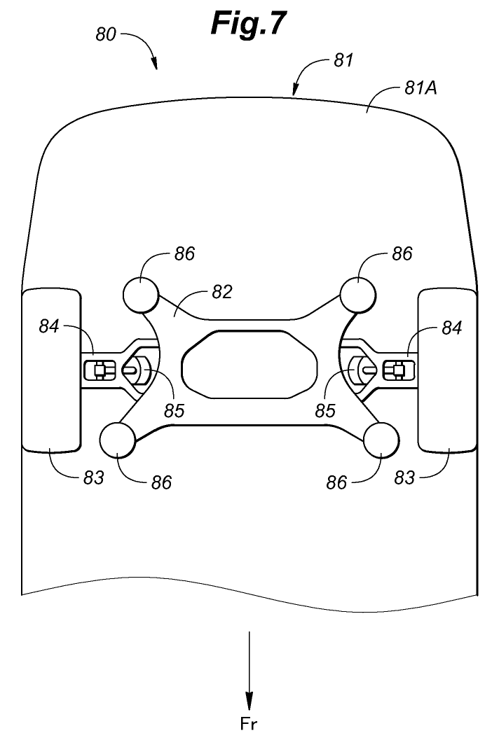

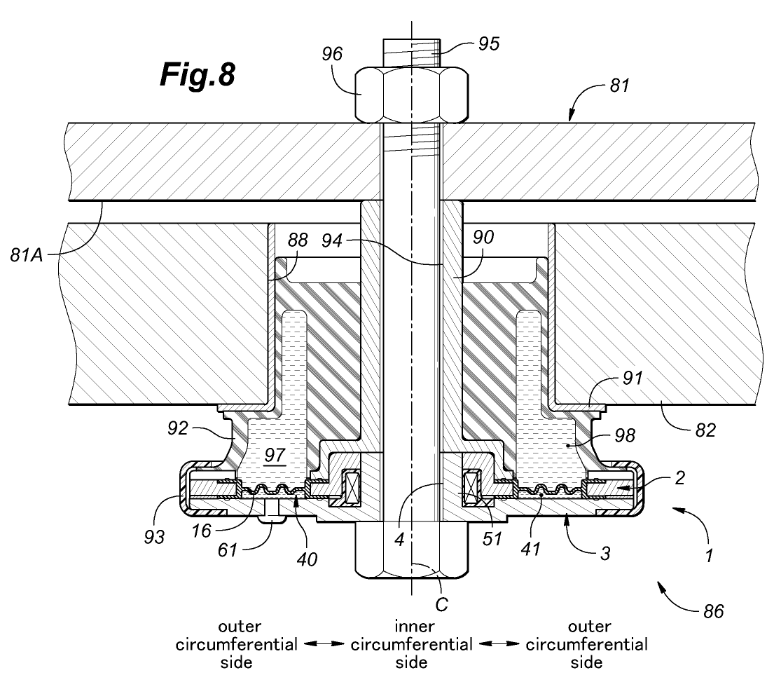

Next, with reference to FIGS. 7 and 8, a vehicle 80 to which the vibration damping device 1 is applied will be described as an application example of the vibration damping device 1. An arrow Fr in FIG. 7 shows the front of the vehicle 80.

With reference to FIG. 7, the vehicle 80 includes a vehicle body 81 extending in the front-and-rear direction, a subframe 82 arranged along a lower surface 81A of the rear portion of the vehicle body 81, left and right rear wheels 83 arranged on the left and right sides of the subframe 82, left and right arms 84 connecting the subframe 82 to the left and right rear wheels 83, left and right suspensions 85 arranged between the left and right arms 84 and the vehicle body 81, and four mounting members 86 attached to the four corners (i.e., a front left corner, a front right corner, a rear left corner, and a rear right corner) of the subframe 82.

With reference to FIG. 8, the subframe 82 is spaced away from the lower surface 81A of the rear portion of the vehicle body 81. The subframe 82 is provided with an attachment hole 88 extending along the up-and-down direction. The attachment hole 88 has a columnar shape centered on the central axis C.

With reference to FIG. 8, each mounting member 86 is arranged between the vehicle body 81 and the subframe 82. Each mounting member 86 includes an inner tubular body 90, an outer tubular body 91 arranged on the outer circumferential side of the inner tubular body 90, an elastic body 92 arranged between the inner tubular body 90 and the outer tubular body 91, the above-mentioned vibration damping device 1 attached to the lower ends of the inner tubular body 90 and the elastic body 92, and a cover 93 arranged on the outer circumferential side of the vibration damping device 1. In FIG. 8, the vibration damping device 1 is arranged upside down relative to the posture in FIG. 1 (i.e., the posture at the completion of manufacture.

The inner tubular body 90 has a cylindrical shape (tubular shape) centered on the central axis C. The inner circumferential surface of the inner tubular body 90 defines a shaft hole 94. The shaft hole 94 is arranged above and coaxially with the central hole 4 of the second tubular portion 51 of the second member 3. The inner tubular body 90 and the second tubular portion 51 are fastened to the vehicle body 81 by a bolt 95 and a nut 96. The bolt 95 penetrates through the shaft hole 94 and the central hole 4.

The outer tubular body 91 has a cylindrical shape (tubular shape) centered on the central axis C. The outer circumferential surface of the outer tubular body 91 fits into the inner circumferential surface of the attachment hole 88 of the subframe 82. Accordingly, the outer tubular body 91 is attached to the subframe 82.

The elastic body 92 has a cylindrical shape (tubular shape) centered on the central axis C. The elastic body 92 is made of an elastic material such as rubber. A primary liquid chamber 97 is defined inside the elastic body 92. The primary liquid chamber 97 has a cylindrical shape (tubular shape) centered on the central axis C. The primary liquid chamber 97 is partitioned from the storing recess 40 of the vibration damping device 1 by the membrane 16. The primary liquid chamber 97 is configured to store a mount liquid 98. The primary liquid chamber 97 communicates with the filling ports (neither of which are shown) respectively provided in the second member 3 and the membrane 16, and can be filled with the mount liquid 98 through these filling ports.

### other modified embodiments

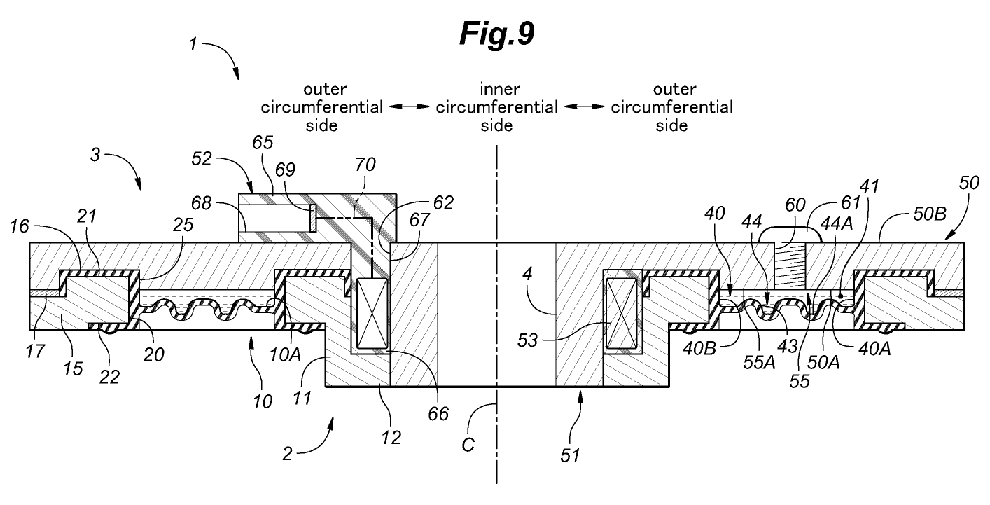

With reference to FIG. 1, in the above embodiment, the length of the storing recess 40 in the radial direction is shorter than the length of the fitting recess 25 in the radial direction, and a step is formed between the storing recess 40 and the fitting recess 25. With reference to FIG. 9, according to another embodiment, the length of the storing recess 40 in the radial direction may be the same as the length of the fitting recess 25 in the radial direction, and a step may not be formed between the storing recess 40 and the fitting recess 25.

In the above embodiment, the second member 3 includes the coil 53. In another embodiment, the first member 2 may include the coil 53.

In the above embodiment, both the outer circumferential surface 25B and the inner circumferential surface 25C of the fitting recess 25 are provided with the protruding portions 30, 31. In another embodiment, only one of the outer circumferential surface 25B and the inner circumferential surface 25C of the fitting recess 25 may be provided with a protruding portion.

In the above embodiment, the mounting member 86 including the vibration damping device 1 is arranged between the vehicle body 81 and the subframe 82. In another embodiment, the mounting member 86 including the vibration damping device 1 may be arranged in a location of the vehicle 80 (for example, the left and right suspensions 85, an engine mount, or a motor mount) other than the above location, or may be arranged on a structure other than the vehicle 80.

### the summary of embodiments

According to one aspect, a liquid filled vibration damping device 1 comprises: a first member 2 having a first surface 10A; and a second member 3 having a second surface 50A facing the first surface 10A, wherein the first surface 10A of the first member 2 is provided with: a storing recess 40 configured to store a liquid 41; and a fitting recess 25 formed continuously with the storing recess 40 and provided on a top surface of the storing recess 40, and the second surface 50A of the second member 3 is provided with a fitting portion 55 configured to fit into the fitting recess 25.

According to this aspect, as the fitting portion 55 fits into the fitting recess 25 after the storing recess 40 is filled with the liquid 41, the liquid 41 can be efficiently stored in the storing recess 40 regardless of the viscosity of the liquid 41. Further, the liquid 41 can be stored in the storing recess 40 without reducing the pressure inside the storing recess 40 beforehand by using a vacuum pump, so that the man-hours to store the liquid 41 can be reduced.

Preferably, the fitting recess 25 and the fitting portion 55 each have an annular shape, at least one of an inner circumferential surface 25C and an outer circumferential surface 25B of the fitting recess 25 is provided with a protruding portion 30, 31, and the fitting portion 55 abuts against the protruding portion 30, 31.

According to this aspect, when the fitting portion 55 fits into the fitting recess 25, the liquid 41 can be prevented from leaking via the gap between the fitting recess 25 and the fitting portion 55.

Preferably, the fitting recess 25 and the fitting portion 55 each have an annular shape, the first surface 10A of the first member 2 is provided with an outer circumferential protrusion 35 on an outer circumference of the fitting recess 25, the second surface 50A of the second member 3 is provided with an outer circumferential recess 56 on an outer circumference of the fitting portion 55, and the outer circumferential protrusion 35 fits into the outer circumferential recess 56.

According to this aspect, the outer circumferential protrusion 35 fits into the outer circumferential recess 56 in addition to fitting of the fitting portion 55 into the fitting recess 25, so that the first member 2 and the second member 3 can be fixed more firmly. Further, by providing a fitting structure of the outer circumferential protrusion 35 and the outer circumferential recess 56 near the storing recess 40, it is possible to prevent the liquid 41 from leaking via the gap between the fitting recess 25 and the fitting portion 55 when the fitting portion 55 fits into the fitting recess 25.

Preferably, the fitting recess 25 and the fitting portion 55 each have an annular shape, the first surface 10A of the first member 2 is provided with an inner circumferential protrusion 36 on an inner circumference of the fitting recess 25, the second surface 50A of the second member 3 is provided with an inner circumferential recess 57 on an inner circumference of the fitting portion 55, and the inner circumferential protrusion 36 fits into the inner circumferential recess 57.

According to this aspect, the inner circumferential protrusion 36 fits into the inner circumferential recess 57 in addition to fitting of the fitting portion 55 into the fitting recess 25, so that the first member 2 and the second member 3 can be fixed more firmly. Further, by providing a fitting structure of the inner circumferential protrusion 36 and the inner circumferential recess 57 near the storing recess 40, it is possible to prevent the liquid 41 from leaking via the gap between the fitting recess 25 and the fitting portion 55 when the fitting portion 55 fits into the fitting recess 25.

Preferably, the first member 2 includes: a first annular portion 10 having an annular shape centered on a central axis C; and a first tubular portion 11 protruding from the first annular portion 10 and having a tubular shape centered on the central axis C, the first annular portion 10 is provided with the storing recess 40 and the fitting recess 25, the second member 3 includes: a second annular portion 50 having an annular shape centered on the central axis C; and a second tubular portion 51 protruding from the second annular portion 50 and having a tubular shape centered on the central axis C, and the second annular portion 50 is provided with the fitting portion 55.

According to this aspect, the storing recess 40 can be formed into an annular shape centered on the central axis C. Accordingly, the liquid 41 stored in the storing recess 40 can efficiently damp vibrations over the entire circumferential area.

Preferably, the storing recess 40 is configured to store a magnetic fluid 41 as the liquid 41, either the first member 2 or the second member 3 includes a coil 53 having a tubular shape centered on the central axis C, and the coil 53 and the storing recess 40 are aligned in a radial direction centered on the central axis C.

According to this aspect, the coil 53 and the magnetic fluid 41 can be aligned in the radial direction centered on the central axis C. According to this arrangement, when an electric current flows through the coil 53, a magnetic field formed around the coil 53 is applied to the magnetic fluid 41, which causes the viscosity and rigidity of the magnetic fluid 41 to change. Accordingly, it is possible to control the damping force of the vibration damping device 1 using the electric current flowing through the coil 53 and thereby damp vibrations efficiently.

Preferably, the second member 3 further includes a connector 52 including a power receiving terminal 69, the connector 52 includes a coil holding portion 66 provided on an outer circumference of the second tubular portion 51, and the coil 53 is held by the coil holding portion 66.

According to this aspect, by fixing the first member 2 and the second member 3, the coil 53 can be mounted on the vibration damping device 1. Accordingly, the man-hours can be reduced as compared to a case where a process of mounting the coil 53 on the vibration damping device 1 is executed separately from a process of fixing the first member 2 and the second member 3.

Preferably, the first member 2 further includes an inner circumferential wall 12 protruding from the first tubular portion 11 toward an inner circumferential side, and an outer circumferential surface of the second tubular portion 51 fits into the inner circumferential wall 12.

According to this aspect, the outer circumferential surface of the second tubular portion 51 fits into the inner circumferential wall 12 in addition to fitting of the fitting portion 55 into the fitting recess 25, so that the first member 2 and the second member 3 can be fixed more firmly.

Preferably, the first annular portion 10 includes: a base member 15 formed integrally with the first tubular portion 11; and an elastic member 16 attached to the base member 15, and the fitting recess 25 is formed by the elastic member 16.

According to this aspect, when the fitting portion 55 fits into the fitting recess 25, the fitting portion 55 can contact more closely with the fitting recess 25. Accordingly, when the fitting portion 55 fits into the fitting recess 25, the liquid 41 can be prevented from leaking via the gap between the fitting recess 25 and the fitting portion 55.

Preferably, the storing recess 40 is recessed from a portion of a bottom surface 25A of the fitting recess 25, and the fitting portion 55 abuts against the bottom surface 25A of the fitting recess 25 so as to cover the top surface of the storing recess 40.

According to this aspect, the fitting portion 55 abuts against the bottom surface 25A of the fitting recess 25, so that the liquid 41 can be prevented from leaking via the gap between the fitting recess 25 and the fitting portion 55.

Preferably, the second member 3 is provided with a through hole 60 penetrating from the second surface 50A to a surface 50B facing away from the second surface 50A, and an end of the through hole 60 close to the second surface 50A opens toward the storing recess 40.

According to this aspect, when the fitting portion 55 fits into the fitting recess 25, the liquid 41 can overflow via the through hole 60, so that the liquid 41 can be defoamed.

According to another aspect, a manufacturing method of the liquid filled vibration damping device 1 comprises: a filling process of filling the storing recess 40 and the fitting recess 25 with the liquid 41; and a fitting process of fitting the fitting portion 55 into the fitting recess 25, wherein after completing the filling process and while performing the fitting process, vacuum defoaming of the liquid 41 is started.

According to this aspect, by the vacuum defoaming of the liquid 41, the pressure of the space formed by the storing recess 40, the fitting recess 25, and the fitting portion 55 (i.e., the space storing the liquid 41) becomes negative, which generates a force that pulls the fitting portion 55 toward the storing recess 40. Accordingly, the fitting portion 55 can fit into the fitting recess 25 with a smaller force.

According to another aspect, a manufacturing method of the liquid filled vibration damping device 1 comprises: a filling process of filling the storing recess 40 and the fitting recess 25 with the liquid 41; and a fitting process of fitting the fitting portion 55 into the fitting recess 25 and thereby causing the liquid 41 in the fitting recess 25 to overflow and defoaming the liquid 41.

According to this aspect, the liquid 41 can be defoamed at the same time as the liquid 41 overflows.

Preferably, after completing the filling process and before starting the fitting process, a sealed space S in which the first member 2 is arranged is vacuumed to defoam the liquid 41.

According to this aspect, the liquid 41 can be defoamed beforehand prior to defoaming of the liquid 41 in the fitting process, so that the liquid 41 can be defoamed more reliably. Further, the defoaming time in the fitting process can be shortened.

This concludes the explanation of the specific embodiment, but the present invention is not limited to the above embodiment or modified embodiment, and can be widely modified and implemented.

Claims:

1. A liquid filled vibration damping device, comprising:
a first member having a first surface; and
a second member having a second surface facing the first surface,
wherein the first surface of the first member is provided with:
a storing recess configured to store a liquid; and
a fitting recess formed continuously with the storing recess and provided on a top surface of the storing recess, and
the second surface of the second member is provided with a fitting portion configured to fit into the fitting recess.

2. The liquid filled vibration damping device according to claim 1, wherein the fitting recess and the fitting portion each have an annular shape,
at least one of an inner circumferential surface and an outer circumferential surface of the fitting recess is provided with a protruding portion, and
the fitting portion abuts against the protruding portion.

3. The liquid filled vibration damping device according to claim 1, wherein the fitting recess and the fitting portion each have an annular shape,
the first surface of the first member is provided with an outer circumferential protrusion on an outer circumference of the fitting recess,
the second surface of the second member is provided with an outer circumferential recess on an outer circumference of the fitting portion, and
the outer circumferential protrusion fits into the outer circumferential recess.

4. The liquid filled vibration damping device according to claim 1, wherein the fitting recess and the fitting portion each have an annular shape,
the first surface of the first member is provided with an inner circumferential protrusion on an inner circumference of the fitting recess,
the second surface of the second member is provided with an inner circumferential recess on an inner circumference of the fitting portion, and
the inner circumferential protrusion fits into the inner circumferential recess.

5. The liquid filled vibration damping device according to claim 1, wherein the first member includes:
a first annular portion having an annular shape centered on a central axis; and
a first tubular portion protruding from the first annular portion and having a tubular shape centered on the central axis,
the first annular portion is provided with the storing recess and the fitting recess,
the second member includes:
a second annular portion having an annular shape centered on the central axis; and
a second tubular portion protruding from the second annular portion and having a tubular shape centered on the central axis, and
the second annular portion is provided with the fitting portion.

6. The liquid filled vibration damping device according to claim 5, wherein the storing recess is configured to store a magnetic fluid as the liquid,
either the first member or the second member includes a coil having a tubular shape centered on the central axis, and
the coil and the storing recess are aligned in a radial direction centered on the central axis.

7. The liquid filled vibration damping device according to claim 6, wherein the second member further includes a connector including a power receiving terminal,
the connector includes a coil holding portion provided on an outer circumference of the second tubular portion, and
the coil is held by the coil holding portion.

8. The liquid filled vibration damping device according to claim 5, wherein the first member further includes an inner circumferential wall protruding from the first tubular portion toward an inner circumferential side, and
an outer circumferential surface of the second tubular portion fits into the inner circumferential wall.

9. The liquid filled vibration damping device according to claim 5, wherein the first annular portion includes:
a base member formed integrally with the first tubular portion; and
an elastic member attached to the base member, and
the fitting recess is formed by the elastic member.

10. The liquid filled vibration damping device according to claim 1, wherein the storing recess is recessed from a portion of a bottom surface of the fitting recess, and
the fitting portion abuts against the bottom surface of the fitting recess so as to cover the top surface of the storing recess.

11. The liquid filled vibration damping device according to claim 1, wherein the second member is provided with a through hole penetrating from the second surface to a surface facing away from the second surface, and
an end of the through hole close to the second surface opens toward the storing recess.

12. A manufacturing method of the liquid filled vibration damping device according to claim 1, the manufacturing method comprising:
a filling process of filling the storing recess and the fitting recess with the liquid; and
a fitting process of fitting the fitting portion into the fitting recess,
wherein after completing the filling process and while performing the fitting process, vacuum defoaming of the liquid is started.

13. A manufacturing method of the liquid filled vibration damping device according to claim 1, the manufacturing method comprising:
a filling process of filling the storing recess and the fitting recess with the liquid; and
a fitting process of fitting the fitting portion into the fitting recess and thereby causing the liquid in the fitting recess to overflow and defoaming the liquid.

14. The manufacturing method of the liquid filled vibration damping device according to claim 12, wherein after completing the filling process and before starting the fitting process, a sealed space in which the first member is arranged is vacuumed to defoam the liquid.

15. The manufacturing method of the liquid filled vibration damping device according to claim 13, wherein after completing the filling process and before starting the fitting process, a sealed space in which the first member is arranged is vacuumed to defoam the liquid.
